(19) United States
(12) Patent Application Publication
(10) Pub. No.: US 2011/0142306 A1
(43) Pub. Date: Jun. 16, 2011

(54) Method and system for generating a medical image

(76) Inventor: Vivek Nair, Bangalore (IN)

(21) Appl. No.: 12/654,278

(22) Filed: Dec. 16, 2009

(51) Int. Cl. G06K 9/00

(52) U.S. Cl. 382/128

(57) ABSTRACT

A method and system for generating a medical image are disclosed. In at least one embodiment, the method involves providing a 3D dataset of a heart and generating a 2D representation of a curved surface of the 3D dataset by flattening out the curved surface of the heart. In at least one embodiment, the 2D representation corresponds to a surface area of the heart covering more than 180 degrees around a circumference of the heart.

### FIELD

At least one embodiment of the present invention generally relates to medical imaging, particularly a method and/or system for generating a medical image of a heart.

### BACKGROUND

Today, the medical imaging community widely accepts Volume Rendering Technique (VRT) as a common way to visualize a volume. The Volume Rendering Technique renders a volume from the 2-dimensional (2D) tomographic slices. In a typical 3-dimensional (3D) rendering of the heart tissue using VRT, the cardiologist has to rotate the 3D VRT model of the heart to view the surface from all angles. The volume might have to be windowed using basic windowing techniques to view the right heart tissues. To get a generic or rather complete picture, the cardiologist will have to visualize the internal heart muscle using a cut plane.

The shape of the heart is somewhat similar to a spherical or oval shaped-object but not entirely. The heart has uneven surfaces. During 3D visualization, the heart also needs to be rotated in 3D space to view the complete surface. To add to the complexity, not all of the heart muscle is visible from outside. We are able to see only the epicardium, which is the outside surface of the heart muscle. For diagnostic purpose the cardiologist needs to visualize the epicardium, myocardium and the endocardium together to evaluate the condition of the heart muscle.

Another problem with the current approach of cardiac visualization is that the intra-ventricular septum, which is also part of the heart muscle, cannot be viewed, as it is located inside the heart chamber. To view all the walls together, the cardiologist has to perform a cross section of the 3D model of the heart using standard cardiac visualizations. The heart muscle can only be displayed using manual windowing of the heart as well as by defining manual cut planes. But still the entire details of the heart are not displayed during the said methodologies.

### SUMMARY

In view of the foregoing, an embodiment herein includes a method of displaying a medical image, comprising providing a 3D dataset of a heart; generating a 2D representation of a curved surface of the 3D dataset by flattening out the curved surface of the heart, such that the 2D representation corresponds to a surface area of the heart covering more than 180 degrees around a circumference of the heart.

In view of the foregoing, another embodiment herein includes a system for displaying a medical image, comprising: a dataset module for providing a 3D dataset of a heart; and a generating module for generating a 2D representation of a curved surface of the 3D dataset by flattening out the curved surface of the heart, such that the 2D representation corresponds to a surface area of the heart covering more than 180 degrees around a circumference of the heart.

In view of the foregoing, an alternate embodiment herein includes a computer program product including a computer readable medium having stored thereon computer executable instructions that, when executed on a computer, configure the computer to perform a method comprising the steps of: providing a 3D dataset of a heart; and generating a 2D representation of a curved surface of the 3D dataset by flattening out the curved surface of the heart, such that the 2D representation corresponds to a surface area of the heart covering more than 180 degrees around a circumference of the heart.

### BRIEF DESCRIPTION OF THE DRAWINGS

The present invention is further described hereinafter with reference to illustrated embodiments shown in the accompanying drawings, in which:

FIG. 1 illustrates a cross section of a heart,

FIG. 2 illustrates a diagram showing the arrangement for the projection of the curved surface of the heart onto a cone according to an embodiment of the invention,

FIG. 3 illustrates a diagram showing the arrangement for the projection of the curved surface of the heart onto a cylinder according to an embodiment of the invention,

FIG. 4 illustrates a general display of the 2D representation of the curved surface of the heart according to an embodiment of the invention,

FIG. 5 shows a 2D representation of the curved surface of the heart and cross section of the walls of the heart according to an embodiment of the invention,

FIG. 6 illustrates a projection of the heart based on a cone, to find the cross sectional representation of the wall,

FIG. 7 illustrates an arrangement for finding the 2D representation of a curved surface of the heart based on separate heart slices according to an embodiment of the invention,

FIG. 8 illustrates an arrangement for finding the cross sectional representation of the wall of the heart based on separate heart slice according to an embodiment of the invention, and

FIG. 9 illustrates another embodiment of the invention explaining a system for generating a medical image.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

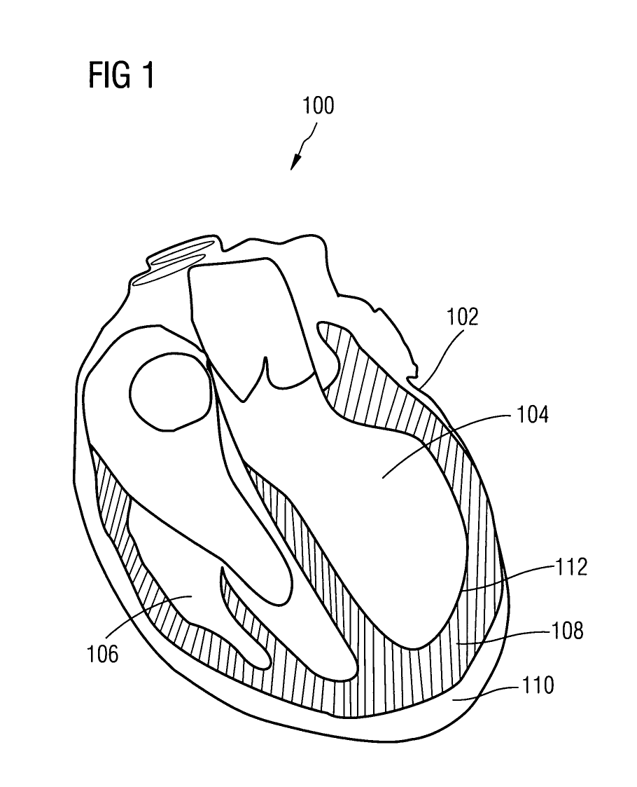

FIG. 1 illustrates a cross section 100 of the heart 102. The left ventricle 104 is one of four chambers (two atria and two ventricles) in the human heart. It receives oxygenated blood from the left atrium via the mitral valve, and pumps it into the aorta via the aortic valve. The left ventricle 104 is longer and more conical in shape than the right ventricle 106. It forms a small part of the sternocostal surface and a considerable part of the diaphragmatic surface of the heart; it also forms the apex of the heart. The left ventricle 104 is thicker and more muscular than the right ventricle 106 because it pumps blood at a higher pressure. By teenage and adult ages, its walls have thickened to three to six times greater than that of the right ventricle 106. This reflects greater pressure workload this chamber performs while accepting blood returning from the pulmonary veins at ˜80 mmHg pressure (equivalent to around 11 kPa) and pushing it forward to the typical ˜120 mmHg pressure (around 16.3 kPa) in the aorta during each heartbeat. One of the main reasons of heart ailments like cardiac arrest is the issues associated with this part of the heart. Even other chambers of the heart are prone to ailments and require monitoring and analysis.

The muscular walls of the heart include three major layers. The bulk of the walls is made up of a layer of cardiac muscle and is called the myocardium 108. The muscle is enclosed on the outside by the epicardium 110 and on the inside by the endocardium 112. Each layer should maintain its appropriate thickness levels to be tagged as healthy. Because of different medical conditions and environment, the thickness levels may reduce or increase from the prescribed healthy threshold levels. The present invention enables the visualization of the whole heart to the cardiologist so that fast and effective conclusions could be made.

The embodiments mentioned in the present invention, basically converts the 3-dimensional dataset image of the heart to a 2-dimensional representation. To enable the method first a 3D dataset of the heart is required. The source of the 3D dataset of the heart could be a live image or could also be a stored image captured previously using any imaging modality. Also this could again be an isolated image of the heart or even could be an image which needs to be isolated for the 3D dataset.

For providing the 2D representation, a cone or cylinder is used to first project the 3D dataset information onto them and then unfold the cone or the cylinder to get the 2D representation. Because cones and cylinder has got zero Gaussian curvature, it is possible to unroll them and analyze their geodesics on the equivalent flat surface. The cones and the cylinder identified for the projection are those which are hollow inside but have only the outer surface. Also in embodiments of the present invention, the word “heart” is understood to cover the whole heart or even a portion of the heart, for example the left ventricle or right ventricle.

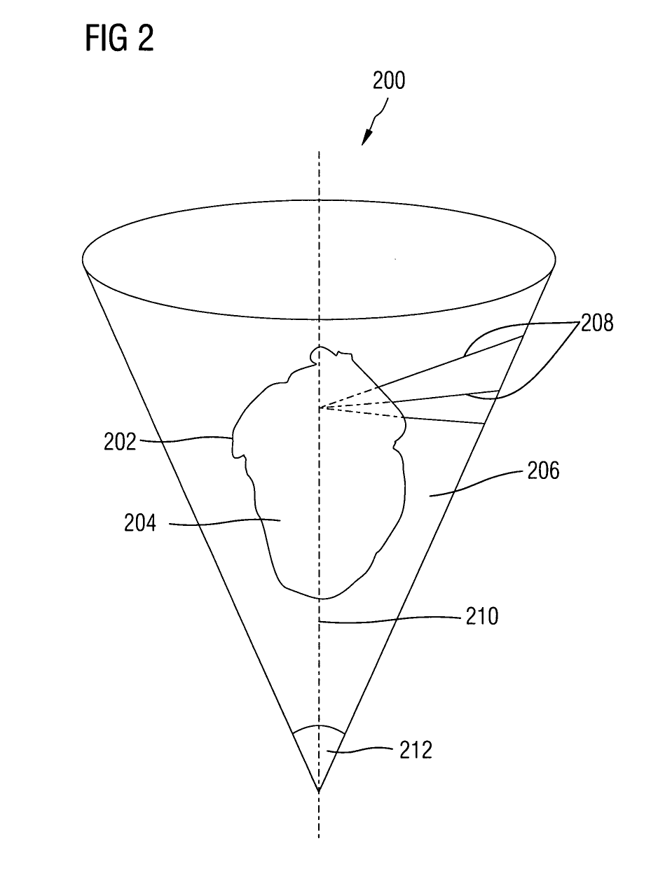

FIG. 2 illustrates the diagram showing the arrangement 200 for the projection of the curved surface 202 of the heart 204 onto a cone 206. The method generating a 2D representation involves, identifying the cone 206 having an axis 210 centralized with respect to the heart. The curved surface 202 is projected along straight lines 208 radially from the axis 210 of the cone 206. The cone 206 has a characteristic geometrical parameter, which is the opening angle 212 selected such that the cone 206 is adapted to the shape of the heart 204. The idea here is to have the cone 206, positioned properly with respect to the heart 204 to have an efficient projection. Then the curved surface 202 of the heart 204 is projected onto the cone 206 and finally the cone 206 is unfolded or flattened out to obtain a flat surface which has the 2D representation of the heart. The same technique could be extended to the whole heart or a portion of the heart like, left ventricle or the right ventricle.

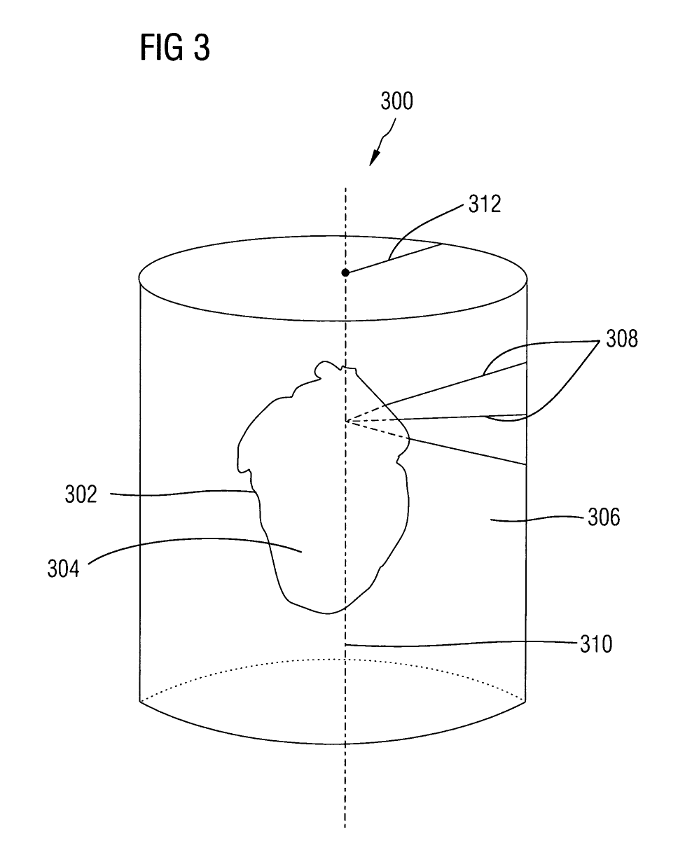

FIG. 3 illustrates the diagram showing the arrangement 300 for the projection of the curved surface 302 of the heart 304 onto the cylinder 306. The curved surface 302 is projected along straight lines 308 radially from the axis 310 of the cylinder 306. The cylinder has a characteristic geometrical parameter, which is the radius 312 selected such that the cylinder 306 is adapted to the shape of the heart 304, to perform an efficient projection.

One embodiment of the invention involves generating a 2D representation of a curved surface of the 3D dataset of the heart by flattening out the curved surface of the heart, projected on the said cone or the cylinder such that the 2D representation corresponds to a surface area of the heart covering the whole circumference of the heart. This would enable the visualization of the heart covering more than 180 degrees around a circumference of the heart, in a display screen or a common display region at a point in time. By flattening out the projection, the arteries also get displayed with the 2D representation of the curved surface.

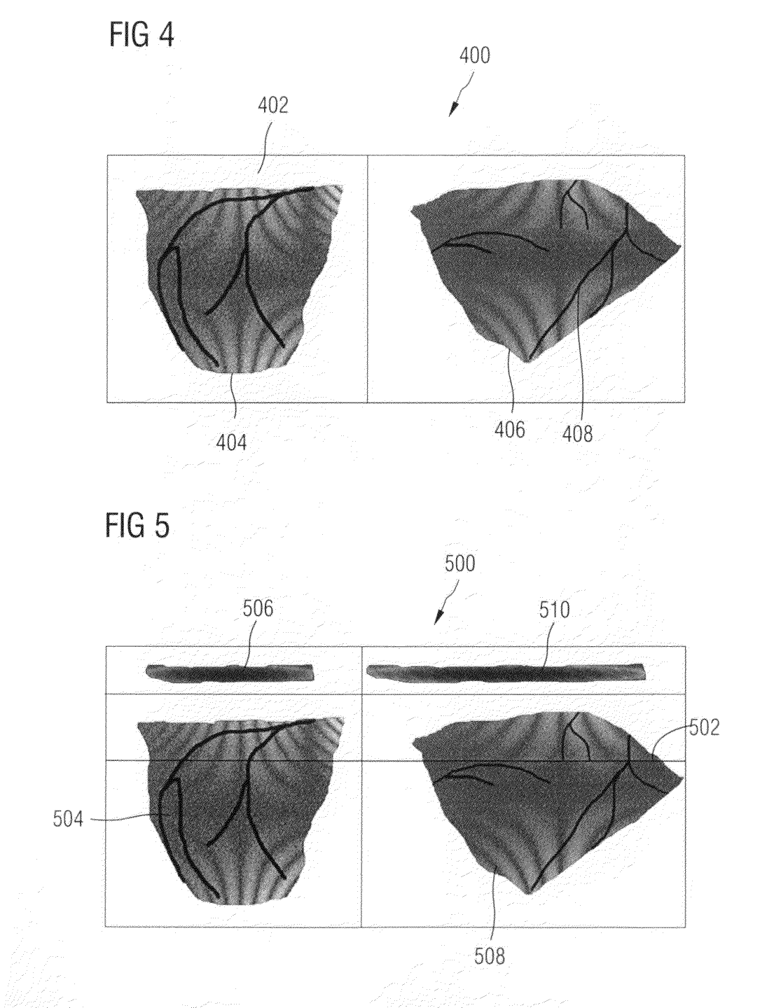

FIG. 4 illustrates a general display 400 of the 2D representation of the curved surface of the heart, after unfolding the cone or the cylinder. The common display region 402 shows the 2D representation of the right ventricle 404 and the left ventricle 406. In this specific representation, two separate projections were performed; one for the right ventricle and the other for the left ventricle of the heart. The 2D representation also shows arteries 408 of the heart, which are projected from the 3D dataset of the heart.

For the cardiologist, to do proper diagnostics the thickness of the wall of the heart is very important. Along with the 2D representation of the curved surface of the heart, if the cardiologist could see the thickness information also, then it would be very useful.

FIG. 5 shows a 2D representation 500 of the curved surface of the heart and the thickness of the walls of the heart according to an embodiment of the invention. To enable this, a reference line 502 is selected, which will run through the 2D representation of the curved surface of the heart. The reference line 502 is not anyway restricted to a straight line. The user could also draw a line, where the wall thickness needs to be seen. It could be a straight line or a curved line or can have various other shapes.

If we consider that FIG. 5, was based on the 2D representation of the projection using the cone, then for the projections along straight lines 208 as shown in FIG. 2, ending on the reference line 502, the distances between the intersections of the straight lines 208 with the inner surface and the outer surface of the wall of the heart is determined. Then a cross sectional representation of the wall of the heart based on the distance information is generated, which basically gives the thickness of the wall. The right ventricle cross section 506 corresponds to the thickness of the wall of the right ventricle 504, where the reference line 502 touches the 2D representation of the curved surface of the right ventricle 504. The left ventricle cross section 510 corresponds to the thickness of the wall of the left ventricle 508, where the reference line 502, touches the 2D representation of the curved surface of the left ventricle 502. The reference line 502 is shown common for both the right and the left ventricle in the FIG. 5. Even there can be separate reference lines for the right and the left ventricle in another embodiment.

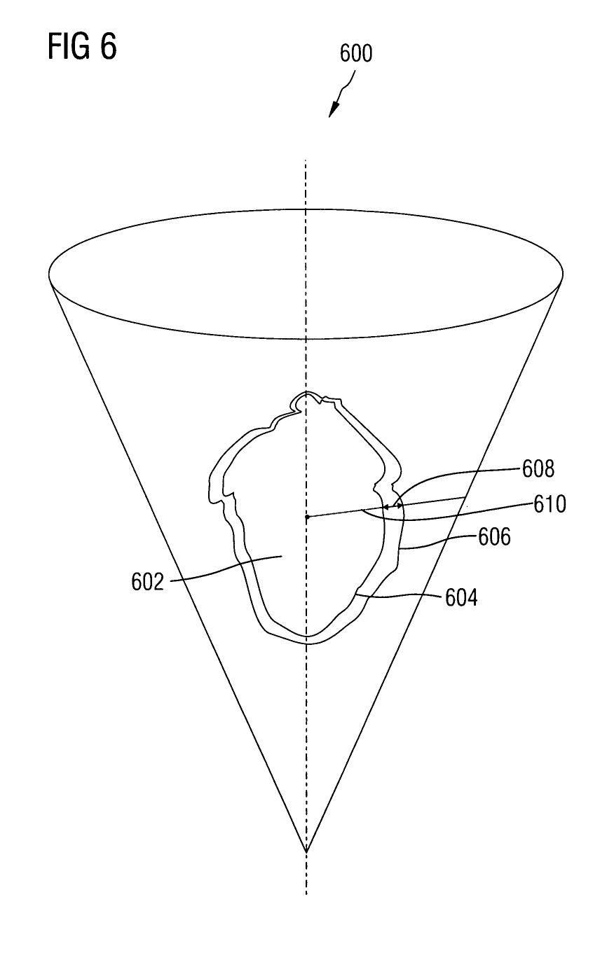

FIG. 6 illustrates a projection 600 based on a cone, to find the cross section representation of the wall as discussed above. The wall of the heart 602 has an inner surface 604 and an outer surface 606. The straight line 610, used for the projection intersects the inner surface 604 and the outer surface 606 of the wall of the heart 602. The distances 608 between the intersections of the straight line 610 with the inner surface 604 and the outer surface 606 is obtained. To get the cross section of the wall of the heart, the distance information obtained for each projected straight lines is determined and then combined to form the 2D representation of the cross section of the wall of the heart.

The 2D representation of the curved surface of the heart and the cross sectional representation of the wall is simultaneously displayed in a common display region as shown in FIG. 5. The cross sectional representation of the wall is changed based on the position of the selected reference line 502 through the 2D representation of the curved surface. The position of the selected reference line 502 is changed by moving the line over the 2D representation of the curved surface. The cross sectional representation of the wall for the selected reference line 502 is displayed orthogonally displaced from the selected reference line 502 next to the 2D representation of the curved surface. In FIG. 5 the cross sectional representation is positioned, to the top of the 2D representation of the curved surface. This relative positioning of the cross sectional representation is not limited to a single direction or arrangement; but could be varied.

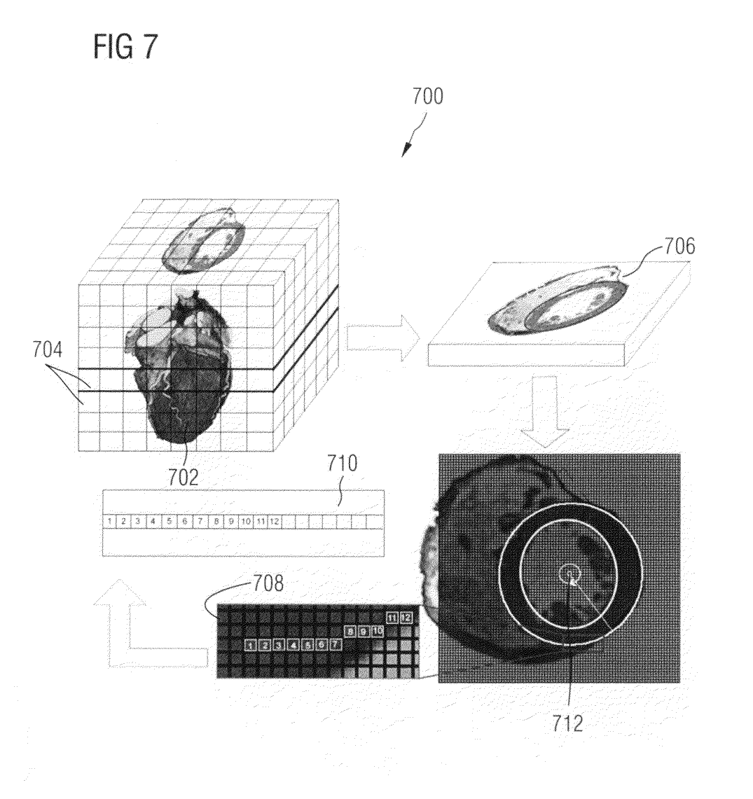

FIG. 7 illustrates an arrangement 700 for finding the 2D representation of a curved surface of the heart 702 according to an embodiment of the invention. The steps involves, separating the 3D dataset of the heart 702 into a plurality of slices 704. Then for each slice 706, 3D dataset points are mapped corresponding to the curved surface to a 2D matrix 708. Finally the 2D matrices of all slices are combined to form the 2D representation 710 of the curved surface of the heart. The mapping performed above, is such that the length of a circumferential line segment on the curved surface in the slice 706 corresponds to the same length in the 2D representation. This type of a mapping will accommodate very less probability of error. The 3D dataset of the heart is separated perpendicular to an axis 712 centralized with respect to the heart. For every slice 706, the 3D dataset points around the circumference of the slice 706 of the heart are mapped to the 2D matrix 708 of the same size. Combining the 2D matrices further comprises, connecting the 2D matrices in a sequence corresponding to the sequence of separation of the slices. The combined 2D matrices finally give the 2D representation of the curved surface of the heart. The same technique could be extended to find the thickness of the wall of the heart.

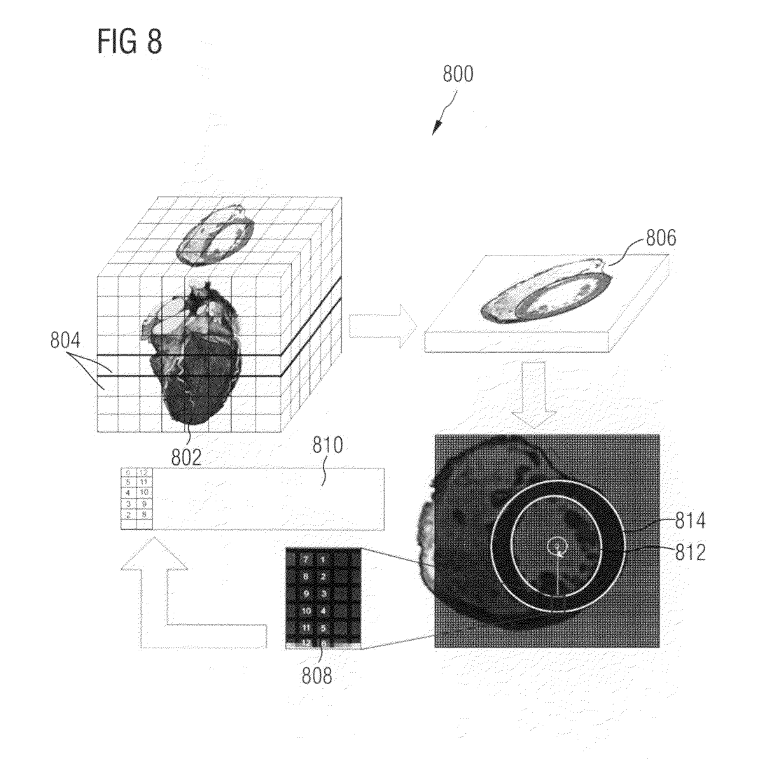

FIG. 8 illustrates an arrangement 800 for finding the cross sectional representation of the wall of the heart according to an embodiment of the invention. Here the steps involves, separating the 3D dataset of the heart 802 into a plurality of slices 804 and for each slice 806, 3D dataset points between the inner surface 812 and the outer surface 814 are mapped to a 2D matrix 808, which corresponds to the thickness of the wall. This is done basically for the whole length of the wall or for a portion of the wall based on the region of the heart selected.

Finally all the 2D matrices captured for that slice 806 are combined to form the 2D representation 810, to form the cross section of the wall of the heart. The point at which the thickness information needs to be shown can also be based similar to that discussed in FIG. 5, where a reference line through the 2D representation of the curved surface is selected. This involves determining thickness measurements of the wall as discussed above at the positions of the curved surface of the heart correspondingly selected by the reference line in the 2D representation and then finally generating the cross sectional representation of the wall of the heart based the thickness measurements. Even the intra-ventricular septum of the heart could be visualized based on the region selected for the 2D representation using the method explained in the invention.

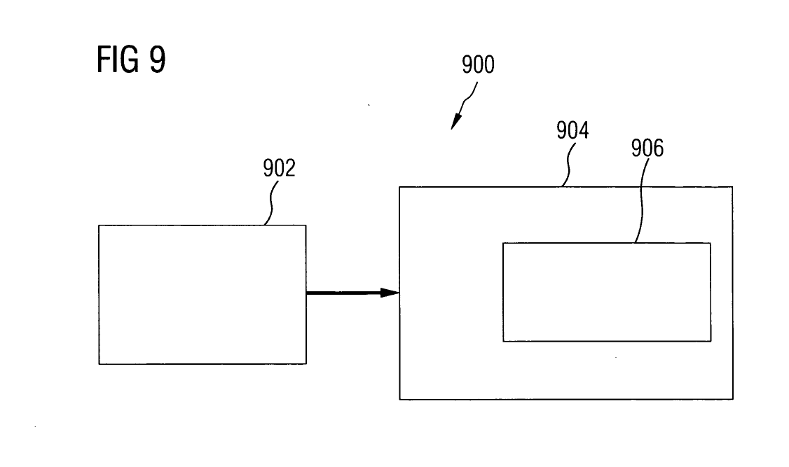

FIG. 9 illustrates another embodiment of the invention explaining a system 900 for displaying a medical image. The system comprises a dataset module 902 for providing a 3D dataset of a heart. The dataset module 902 could be a part of an image capturing modality or could be part of a storage system, where the images might reside. The system further has a generating module 904 for generating a 2D representation of a curved surface of the 3D dataset by flattening out the curved surface of the heart, such that the 2D representation corresponds to a surface area of the heart covering more than 180 degrees around a circumference of the heart. The generating module 904 further has a display region 906 to display the 2D representation. Even the display region 906 could be an independent display module, connected to the generating module 904.

The said method in an embodiment of the invention could also be implemented using a computer program product. It includes a computer readable medium having stored thereon computer executable instructions that, when executed on a computer, configure the computer to perform the said method of providing a 3D dataset of a heart; and generating a 2D representation of a curved surface of the 3D dataset by flattening out the curved surface of the heart, such that the 2D representation corresponds to a surface area of the heart covering more than 180 degrees around a circumference of the heart.

Although the invention has been described with reference to specific embodiments, this description is not meant to be construed in a limiting sense. Various modifications of the disclosed embodiments, as well as alternate embodiments of the invention, will become apparent to persons skilled in the art upon reference to the description of the invention. It is therefore contemplated that such modifications can be made without departing from the embodiments of the present invention as defined.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, computer readable medium and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method of generating a medical image, comprising:
providing a 3D dataset of a heart;
generating a 2D representation of a curved surface of the 3D dataset by flattening out a curved surface of the heart, such that the 2D representation corresponds to a surface area of the heart covering more than 180 degrees around a circumference of the heart.

2. The method according to claim 1, wherein the generating of the 2D representation further comprises:
identifying a cone or a cylinder having an axis centralized with respect to the heart;
projecting the curved surface of the heart onto the identified cone cylinder; and
unfolding the identified cone or cylinder to a flat surface.

3. The method according to claim 2, wherein the identified cone or cylinder has a characteristic geometrical parameter, which is selected such that the identified cone or cylinder is adapted to the shape of the heart.

4. The method according to claim 3, wherein the characteristic geometrical parameter is a radius of the cylinder.

5. The method according to claim 3, wherein the characteristic geometrical parameter is an opening angle of the cone.

6. The method according to claim 2, wherein the curved surface is projected along straight lines extending radially from the axis to the identified cone or cylinder.

7. The method according to claim 6, wherein the curved surface of the 3D dataset has an inner surface or an outer surface of a wall of the heart and the method further comprises:
selecting a reference line through the 2D representation of the curved surface, for the projections along straight lines ending on the reference line,
determining distances between intersections of the straight lines with the inner surface and the outer surface; and
generating a cross sectional representation of the wall of the heart based on the determined distances.

8. A method according to claim 1, further comprising:
separating the 3D dataset of the heart into a plurality of slices;
mapping, for each of the plurality of slices, 3D dataset points corresponding to the curved surface to a 2D matrix; and
combining the 2D matrices of all of the plurality of slices to form the 2D representation.

9. The method according to claim 8, wherein the mapping is such that a length of a circumferential line segment on the curved surface in on of the plurality of slices corresponds to the same length in the 2D representation.

10. The method according to claim 8, wherein the 3D dataset of the heart is separated perpendicular to an axis centralized with respect to the heart.

11. The method according to claim 8, wherein for every slice, the 3D dataset points are mapped to the 2D matrix of the same size.

12. The method according to claim 8, wherein combining the 2D matrices further comprises, connecting the 2D matrices in a sequence corresponding to the sequence of separation of the slices.

13. The method according to claim 8, wherein the curved surface of the 3D dataset has an inner surface or an outer surface of the wall of the heart and wherein the method further comprises:
selecting the reference line through the 2D representation of the curved surface;
determining thickness measurements of the wall at positions of the wall correspondingly selected by the reference line in the 2D representation; and
generating the cross sectional representation of the wall of the heart based the determined thickness measurements.

14. The method according to claim 1, wherein the curved surface of the 3D dataset has an inner surface or an outer surface of the wall of the heart and wherein the method further comprises:
selecting the reference line through the 2D representation of the curved surface;
determining thickness measurements of the wall at positions of the wall correspondingly selected by the reference line in the 2D representation; and
generating the cross sectional representation of the wall of the heart based on the determined thickness measurements.

15. The method according to claim 14, further comprises simultaneously displaying the 2D representation of the curved surface and the cross sectional representation of the wall in a common display region.

16. The method according to claim 14, wherein the cross sectional representation of the wall is changed based on the position of the selected reference line through the 2D representation of the curved surface.

17. The method according to claim 15, wherein the position of the selected reference line is changed by moving the line over the 2D representation of the curved surface.

18. The method according to claim 14, wherein the cross sectional representation of the wall along the selected reference line is displayed orthogonally displaced from the selected reference line next to the 2D representation.

19. A system for generating a medical image, comprising:
a dataset module to provide a 3D dataset of a heart; and
a generating module to generate a 2D representation of a curved surface of the 3D dataset by flattening out a curved surface of the heart, such that the 2D representation corresponds to a surface area of the heart covering more than 180 degrees around a circumference of the heart.

20. A computer program product including a computer readable medium having stored thereon computer executable instructions that, when executed on a computer, configure the computer to perform a method comprising:
providing a 3D dataset of a heart; and
generating a 2D representation of a curved surface of the 3D dataset by flattening out a curved surface of the heart, such that the 2D representation corresponds to a surface area of the heart covering more than 180 degrees around a circumference of the heart.

21. A computer readable medium including program segments for, when executed on a computer device, causing the computer device to implement the method of claim 1.
